(19) United States
(12) Patent Application Publication
(10) Pub. No.: US 2025/0272219 A1
(43) Pub. Date: Aug. 28, 2025

(54) CELL BASED TEST AUTOMATION FRAMEWORK

(71) Applicant: NetApp, Inc., San Jose, CA (US)

(72) Inventor: Amalraj Victory Raja, Bengaluru (IN)

(21) Appl. No.: 18/584,176

(22) Filed: Feb. 22, 2024

(51) Int. Cl. G06F 11/36; G06F 11/34; G06F 21/60

(52) U.S. Cl. CPC G06F 11/3688; G06F 11/3476; G06F 11/3698; G06F 21/602

(57) ABSTRACT

Techniques are provided for a cell based test automation framework. Conventional plain-text based test automation frameworks require extensive knowledge of scripting/programming languages to create and debug test scripts with numerous lines of code written in plain-text. Thus, conventional plain-text based test automation frameworks are disadvantageous in terms of time, effort, and training costs. The disclosed cell based test automation framework overcomes these disadvantages by utilizing spreadsheets defining a test script to execute. Each sheet within a spreadsheet defines a test case that the cell based test automation framework is to execute. The testing spreadsheet include cells storing test data and control values. The control values are used to control the flow of executing the test script to perform a test using the test data. The spreadsheet is very easy for a developer to create, and the cell based test automation framework outputs logs that are easy to read, understand, and debug.

### BACKGROUND

A test automation framework includes a set of components that facilitate the execution of tests, and provide reporting of test results. The test automation framework may include testing tools, scripts, procedures, and/or other components for testing software. There are various types of test automation frameworks, such as linear automation frameworks, modular driven frameworks, behavior driven development frameworks, data driven frameworks, etc. The test automation framework allows a developer to test software within a particular computing environment such as to determine whether storage software is capable of successfully creating volumes, renaming volumes, creating snapshots, deleting snapshots, replicating data, etc.

### DESCRIPTION OF THE DRAWINGS

Embodiments of the present technology will be described and explained through the use of the accompanying drawings in which:

FIG. 1 is a block diagram illustrating an embodiment of a system for implementing a cell based test automation framework in accordance with an embodiment of the present technology.

FIG. 2 is a flow chart illustrating an embodiment of a method for implementing a cell based test automation framework in accordance with various embodiments of the present technology.

FIG. 3 is a block diagram illustrating an embodiment of a system for implementing a cell based test automation framework in accordance with various embodiments of the present technology.

FIG. 4 is a block diagram illustrating an embodiment of a system for implementing a cell based test automation framework in accordance with various embodiments of the present technology.

FIGS. 5A-5E are embodiments of spreadsheets used by a cell based test automation framework to perform a test in accordance with an embodiment of the present technology.

FIG. 6 is an embodiment of test command line syntax used by a cell based test automation framework to perform a test in accordance with an embodiment of the present technology.

FIGS. 7A-7B are embodiments of test results output by a cell based test automation framework while performing a test in accordance with an embodiment of the present technology.

FIGS. 8A-8B are embodiments of test results output by a cell based test automation framework while performing a test in accordance with an embodiment of the present technology.

FIG. 8C is an embodiment of a debugger of a cell based test automation framework in accordance with an embodiment of the present technology.

FIG. 9 is a block diagram illustrating an example of a node in accordance with various embodiments of the present technology.

FIG. 10 is an example of a computer readable medium in accordance with various embodiments of the present technology.

The drawings have not necessarily been drawn to scale. Similarly, some components and/or operations may be separated into different blocks or combined into a single block for the purposes of discussion of some embodiments of the present technology. Moreover, while the present technology is amenable to various modifications and alternative forms, specific embodiments have been shown by way of example in the drawings and are described in detail below. The intention, however, is not to limit the present technology to the particular embodiments described. On the contrary, the present technology is intended to cover all modifications, equivalents, and alternatives falling within the scope of the present technology as defined by the appended claims.

### DETAILED DESCRIPTION

Various embodiments of the present technology relate to a cell based test automation framework. Test automation frameworks are used to test software before the software is put into production so that issues and bugs can be identified and resolved without affecting a production environment. Software testing is an essential step in the development life cycle, and is performed to ensure that high quality software products and services are provided to users. Manually testing is time consuming, expensive, and requires a lot of effort and in-depth knowledge, and thus test automation frameworks have been developed to automate the process of testing software and generating testing reports. A test automation framework allows a software developer to identify bugs at an early stage in development, thus reducing the time and effort required to perform manual testing.

Many conventional test automation frameworks utilize plain text as input for testing software. With these plain-text based test automation frameworks, developers must have extensive knowledge on scripting and programming languages in order to draft test scripts that are tested by the plain-text based test automation frameworks. Some plain-text based test automation frameworks may have a built-in reporting and logging mechanism, which generates HTML and XML reports. Other plain-text based test automation frameworks do not support built-in reporting and logging features, and thus require integration with other tools for logging and reporting out the results of a test.

Because the test scripts are generally written in plain text with numerous lines of code, identifying scripting errors is difficult and requires extensive debugging skills in order to parse through and understand the code written in plain text. The plain-text based test automation framework may require a machine with a high-end configuration with ample resources so that the plain-text based test automation framework can handle the significant amount of libraries that may be used when testing a test script written in plain text.

Test execution performed by the plain-text based test automation framework for a test script produces cluttered console and test logs that take a significant amount of time to analyze for script issues and software product issues. For example, a conventional plain-text based test automation framework captures logs for each line of code in the test script and captures logs for variable assignments, which may not be required for typical testing. Capturing such as large amount of information, which may be unnecessary for typical testing, results in huge file size logs that are unwieldy for manual review. The logs may be too cluttered and too large for analysis, and become more unwieldy at scale. Consequently, conventional plain-text based test automation frameworks are disadvantageous in terms of time, effort, and cost such as for training users to be able to parse through the huge file size logs in order to adequately analyze the logs for script issues and software product issues.

Another disadvantage associated with conventional plain-text based test automation frameworks is that the output is missing modularity in script lines. In general, commenting a single line in a test script is easy. However, it become tedious to comment numerous lines of the test script, such as when all, but a few lines, are to be commented. Therefore, a developer must understand the script flow of the test script to ensure that commenting on a line will not have a side effect on upcoming lines within the test script during testing. Furthermore, conventional plain-text based test automation frameworks do not support commenting on one or more selected arguments in a method call. In an example of a method call ‘ADD_NUMBERS (10, 20, 30)’, the value 20 cannot be commented alone even if the value 20 is not required. The developer is unable to alter or override the values of variables inside the test script from a command line. Also, test script execution by a plain-text based test automation framework cannot be paused at any time from outside of the shell where the test is being executed, thus making testing even further cumbersome.

Further limitations of conventional plain-text based test automation frameworks relate to the inability to use color coding for script lines, a particular command, or a parameter in a plain-text based test script. Conventional plain-text based test automation frameworks generate a final log in HTML or a plain text file, which cannot be converted into a dictionary object that could otherwise be used to iterate on logs for certain use cases. Also, there is no flow control over lines of code unless multiple IF statement blocks are used in the test script. Another limitation is that if there is a product API or any new API is required to be updated within the conventional plain-text based test automation framework, then it requires lot of code changes in multiple files and also an explicit request must be sent for review/approval for the code changes before the API can be merged into the flow of testing.

The disclosed cell based test automation framework overcomes these deficiencies of conventional test automation frameworks by operating on spreadsheets defining test scripts instead of plain-text based test scripts. That is, the cell based test automation framework is configured with functionality that is capable of performing tasks using spreadsheet based test scripts. Each sheet of a testing spreadsheet may correspond to a test case to run. The testing spreadsheet includes both test data for the test, and control flag cells with control values that lead the flow of test execution using the given test data. In this way, the testing spreadsheet defines a test script of a test that is performed by the cell based test automation framework. The spreadsheet is very easy for a developer to create, and the cell based test automation framework outputs logs that are easy and clear to read, understand, and debug.

The test script may comprise of one or more steps, and each step may further comprise one or more threads. In some embodiments, a thread is defined as a row within the testing spreadsheet. Each thread may comprise an application programming interface (API) call, a utility method call, or other call. Because the thread itself includes predefined methods to trigger the call, there is no longer a need to write a separate method (code) for each API. The flow of the cell based test automation framework performing the steps and threads may be controlled by test control flags and flow control flags (e.g., values within the control flag cells of the testing spreadsheet). In some embodiments, the threads of a single step may be executed in parallel by default. However, a control flag can be used to control the cell based test automation framework to serially execute each thread.

The cell based test automation framework supports a variety of controls flags that provide an improved, easier, and faster automation test experience. For example, the cell based test automation framework supports control flags to perform conditional and unconditional skips, jumps, exits, and pauses amongst steps and threads (e.g., skip a particular step if a current step fails, jump to a particular step if a current thread passes, pause text execution, etc.). The cell based test automation framework supports test log flags, status control flags, and/or test verification flags (e.g., verify a count of listed items in a response output by an API called by a thread, a flag to truncate output from the response that is not needed in a log, etc.). The cell based test automation framework supports flow mode changer flags, thread control flags, and/or batch control flags (e.g., a number of times to retry a thread to get a desired result, executing threads quicker by ignoring some validation checks, executing threads as batches when a thread count in a step is large, etc.). In this way, the control flags, specified by the testing spreadsheet, are used by the cell based test automation framework to control the flow of the test.

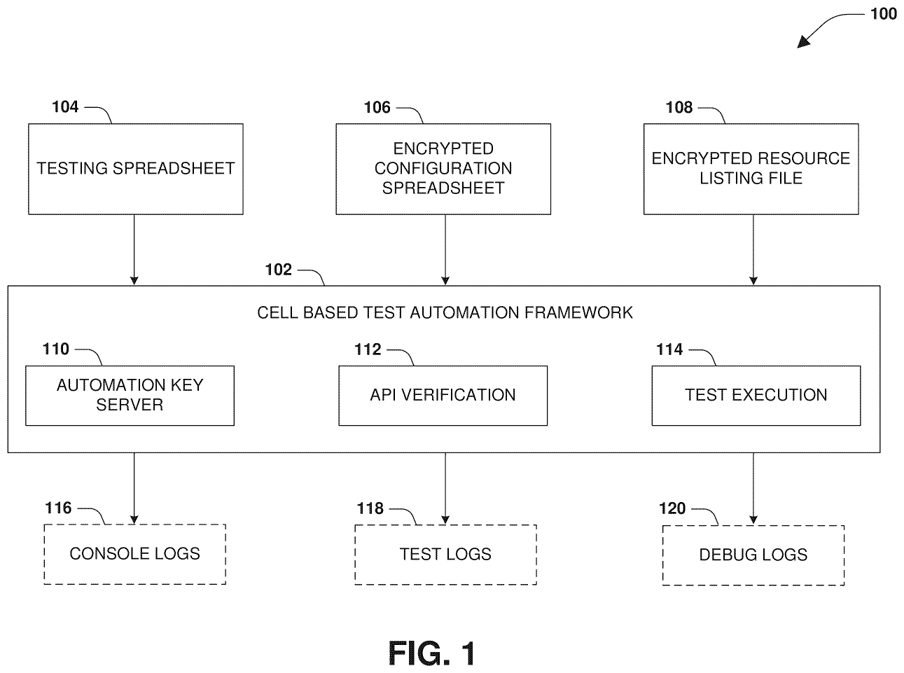

FIG. 1 is a block diagram illustrating an embodiment of a system 100 for implementing a cell based test automation framework 102. The cell based test automation framework 102 is capable of performing tests within a computing environment such as to test whether storage software can successfully create, rename, or delete a volume within a storage environment. Unlike conventional plain-text based test automation frameworks that have the aforementioned disadvantages, the cell based test automation framework 102 is able to overcome these disadvantages by perform tests that are defined through a testing spreadsheet 104. The testing spreadsheet 104 defines a test case script using values populated within cells of the testing spreadsheet 104. The cells may be populated with test data for performing the test within the computing environment. The calls may be populated with values describing a call such as an application programming interface (API) call to the storage software for performing an operation such as creating a snapshot of the volume. Some cells may be designated as control flag cells that are populated with control values used to control a flow for executing the test using the test data. Each sheet within the testing spreadsheet 104 is used to define a test case, and thus a workbook within the testing spreadsheet 104 defines a group of test cases (test suite) for the cell based test automation framework 102 to perform.

The control flag cells may be populated with skip control values (e.g., skip a current step or thread if a specified step or thread fails, passes, or is skipped), jump control values (e.g., jump to a specified step if a current step or thread fails or passes), exit control values (e.g., exit test execution if a current step or thread fails or passes), pause control values (e.g., pause execution from a current step or thread and enter into a debug mode if a specified step or thread fails, passes, or is skipped), thread control values (e.g., a number of times to retry a thread, a time to wait for a retry loop, or a sleep time after execution of each thread or step), and/or batch control values (e.g., a delay before or after execution of a batch, execute threads in batches per a specified count, etc.). The control flag cells may be populated with test log control values, status control values, test verification control values, serial mode flow control values, and/or quick mode flow control values.

In some embodiments, the cell based test automation framework 102 utilizes a configuration spreadsheet and/or a resource listing file (e.g., a swagger file describing resources of the computing environment, such as storage function APIs available to call) for performing the test or for preparing to perform the test. In some embodiments, the cell based test automation framework 102 utilizes an automation key server 110 to provide a key to decrypt an encrypted configuration spreadsheet 106 to obtain the configuration spreadsheet and decrypt an encrypted resource listing file 108 to obtain the resource listing file. The configuration spreadsheet may include setup configurations for executing the test (e.g., sensitive configuration information that is stored in an encrypted format for security, whereas other non-sensitive configuration information may be stored within the testing spreadsheet 104). The resource listing file may define APls and/or other resources that are available to call using the test data within the testing spreadsheet 104 for performing the test (e.g., a snapshot API for creating a snapshot).

The cell based test automation framework 102 parses the testing spreadsheet 104 such as to convert the testing spreadsheet 104 into a JSON format or other format that can be used by the cell based test automation framework 102 to perform the test. The cell based test automation framework 102 may also parse the configuration information from the configuration spreadsheet for performing the test. The testing spreadsheet 104 is parsed to identify steps, threads, test data, and control values to use for performing the test, which may be reformatted into the JSON or other format for executing the test case script defined by the testing spreadsheet 104. A step may include one or more threads, and a thread includes a call to a resource such an API call to the snapshot, volume, backup or any API.

The cell based test automation framework 102 may perform an API verification 112 by comparing calls defined by threads with calls listed within the resource listing file. If there is a mismatch, then an error report is generated. Otherwise, the cell based test automation framework 102 continues with executing the test script (e.g., a test script in the JSON format that was created by parsing the testing spreadsheet 104 and/or the configuration spreadsheet).

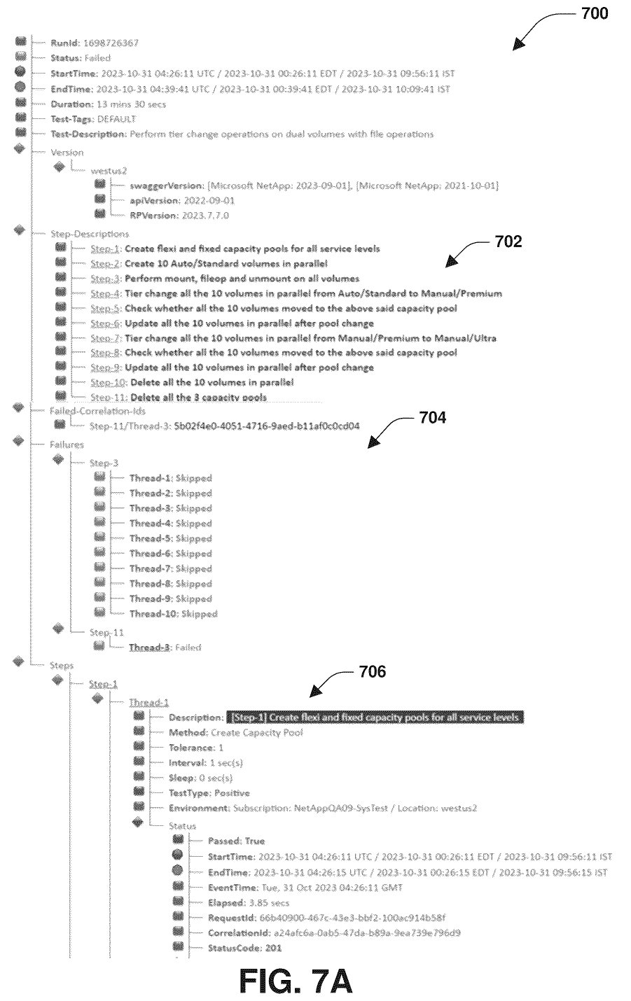

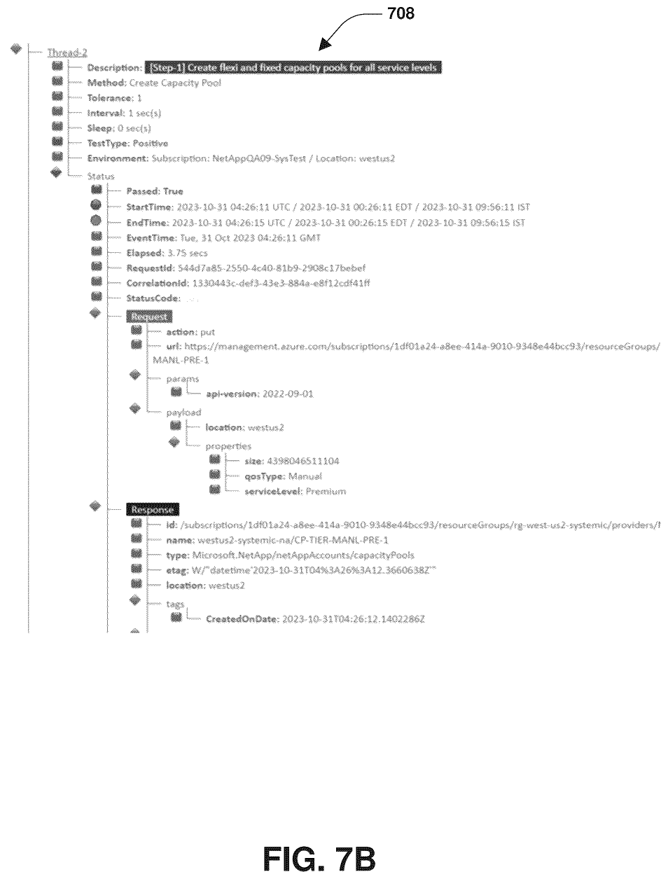

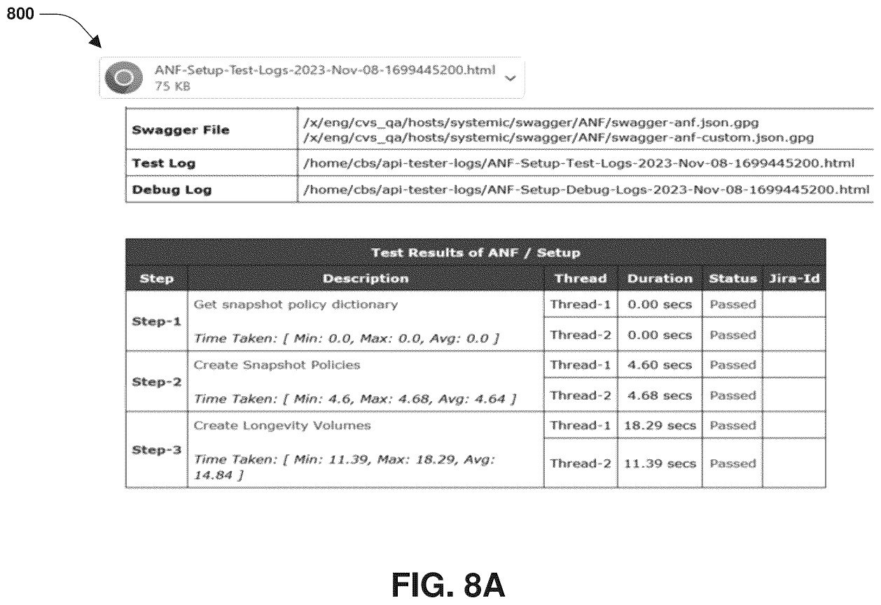

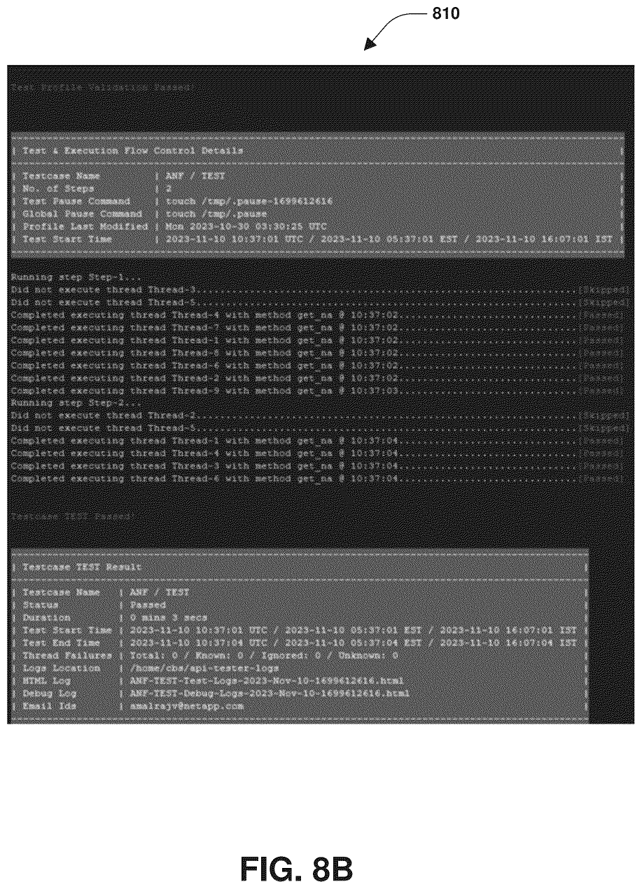

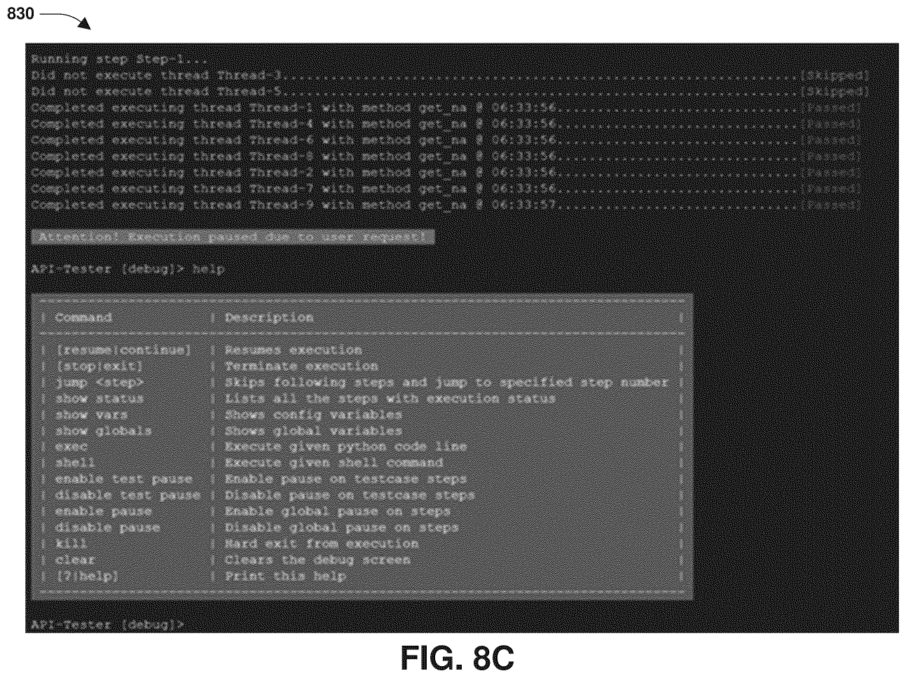

The cell based test automation framework 102 proceeds with test execution 114 by utilizing the control values and configuration information (e.g., parsed and extracted into the JSON format from the testing spreadsheet 104 and configuration spreadsheet) to perform calls, defined by the threads, using the test data. The cell based test automation framework 102 generates console logs 116, test logs 118, and/or debug logs 120 based upon the test execution 114. The console logs 116 may specify that a particular step was run, what threads of the step were executed and whether the threads passed, failed, skipped, errored, and what threads of the step were not executed. An embodiment of console logs is illustrated by FIG. 8B. The debug logs 120 may correspond to logs created when execution of the test script is paused so that a user can utilize a debug console to interact with execution of the test script. An embodiment of a debug console is illustrated by FIG. 8C. The test logs 118 may specify what steps were performed, what threads were executed or skipped, and test results. An embodiment of the test logs 118 is illustrated by FIGS. 7A and 7B. In this way, the cell based test automation framework 102 completes execution of the test script, and the user is provided with access to the console logs 116, the test logs 118, and/or the debug logs 120.

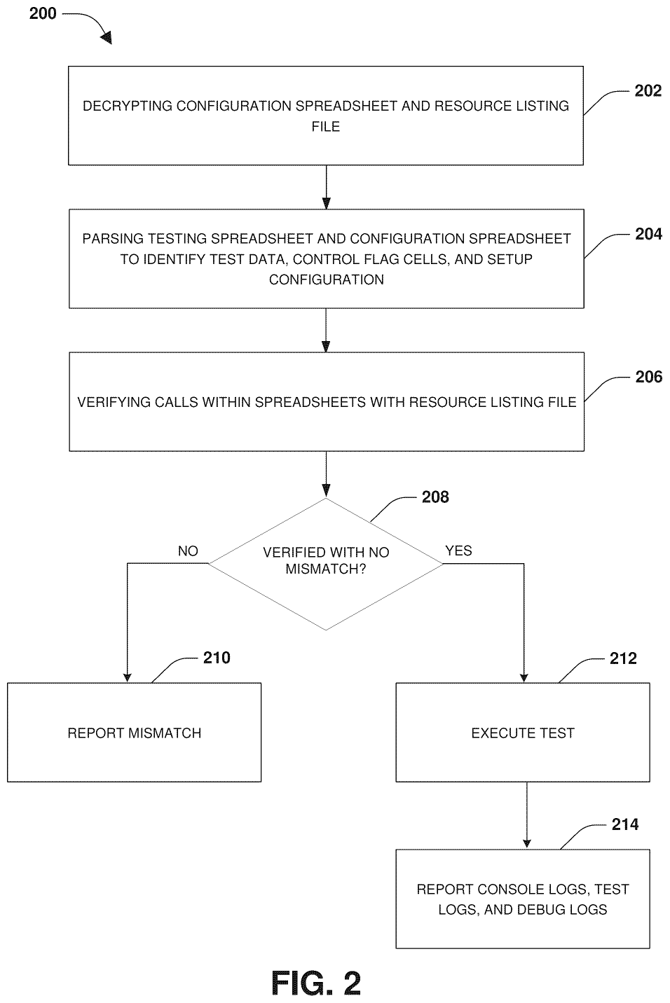

FIG. 2 is a flow chart illustrating an embodiment of a method 200 for implementing a cell based test automation framework. A testing spreadsheet may comprise sheets representing test cases, and a workbook representing a group of test cases that can be tested by the cell based test automation framework. Each sheet, representing a test case to perform, includes cells populated with test data for performing the test case within a computing environment and control values within control flag cells used to control a flow for executing the test case using the test data within the sheet. In this way, the testing spreadsheet represents a test script that can be executed by the cell based test automation framework.

In some embodiments, the control flag cells include skip control values, jump control values, exit control values, and pause control values, which may be conditional or unconditional. For example, the control flag cells include conditional values such as: skiplfFailed—skip the current step or thread if the specified step or thread is failed; skiplfPassed—skip the current step or thread if the specified step or thread is passed; skiplfSkipped—skip the current step or thread if the specified step or thread is skipped. The control flag cells include conditional values such as: jumplfFailed—jump to the specified step if the current step or thread failed and jumplfPassed—jump to the specified step if the current step or thread passed. The control flag cells include unconditional values such as: exitlfFailed—exit from test execution if the current step or thread failed and exitlfPassed—exit from test execution if the current step or thread passed. The control flag cells include conditional values such as: pauselfFailed—pause the execution from the current step or thread and enter into debug mode if the specified step or thread is failed; pauselfPassed—pause the execution from the current step or thread and enter into debug mode if the specified step or thread is passed; and pauselfSkipped—pause the execution from the current step or thread and enter into debug mode if the specified step or thread is skipped.

In an example, the control flag cells include conditional values such as: skipNow or skipMe—skip the current step or thread and proceed to next step; jumpNow—jump to the specified step unconditionally irrespective of the current step result; exitNow—exit from the test execution unconditionally irrespective of the current step result; and pauseNow—pause the test execution unconditionally irrespective of the current step result and enter into debug mode.

In some embodiments, the control flag cells include thread control values and batch control values. For example, the control flag cells include thread control values such as tolerance—a number of times to retry the thread to get the desired result; interval—a number of seconds to wait for the above retry loops; threadSleep—a number of sleep seconds after the execution on each thread; stepSleep—a number of sleep seconds after the execution on each step; threadDelay—a number of sleep seconds before the execution on each thread; and stepDelay—a number of sleep seconds before the execution on each step. For example, the control flag cells include batch control values such as batchCount—when thread count is high in a step, batchCount helps to execute threads in batches as per the given count where threads in batches could be executed in parallel or serial using a modeSerial flag; batchSleep—a number of sleep seconds after the execution of each batch; and batchDelay—a number of sleep seconds before the execution of each batch.

In some embodiments, the control flag cells include test log control values, status control vlaues, test verification control values, a serial mode flow control value, and/or a quick mode flow control value. For example, the control flag cells includes trimMe—boolean flag to truncate large output in a response to a call from a thread if part of the output is not needed in the log, but the output will be available till the end of the test in runtime to iterate on it; dontCare—thread will be shown as passed in the log but the thread is treated as failed internally until the end of the test for processing if needed for any action in runtime; verify—verify the complete dict (e.g., dictionary) of the thread output for the desired dict and its values; verifyCount—verify the count of list items in the response output; verifyPattern—verify the string with pattern in the response output; expectError—verify the output for the expected error in the response output; expectPass—boolean flag to verify the thread resulted in pass or fail and a negative test can be done by setting False for this boolean flag on one or more threads; expectCodes—verify the response for one or more expected HTTP return codes or custom status code for a thread; modeSerial—by defaults all threads in a step will be executed in parallel, which will execute in serial if this flag is set as true; and modeQuick—some extra validation checks are ignored and threads will be executed quick if this flag is set as true.

In some embodiments, a prefix character may be assigned to a value within a cell in order to trigger the cell based test automation framework to treat the value in a certain manner. Any character and/or any number of characters may be used as the prefix character such as a hashtag # or any other character(s). In some embodiments, a thread corresponds to a row within the testing spreadsheet. If a value within a cell of that row has the prefix character, then a call (e.g., an API call) of the thread will exclude that value from a payload of the call. In some embodiments, the prefix character is assigned to a variable name within the testing spreadsheet in order to declare and access the variable. In this way, test data, control values, variables, and/or other information used to execute a test script are populated within the testing spreadsheet.

The cell based test automation framework may also utilize a configuration spreadsheet and resource listing file as part of executing the test script. The configuration spreadsheet and resource listing file may be maintained as encrypted files, and thus the configuration spreadsheet and resource listing file are decrypted, during operation 202 of method 200. In some embodiments, an automation key server is used to provide a key to decrypt an encrypted resource listing file to obtain the resource listing file and to decrypt a configuration spreadsheet to obtain a setup configurations for executing the testing script to perform the test within the computing environment.

During operation 204 of method 200, the testing spreadsheet, defining the test case script, is parsed to identify the test data for performing the test and to identify the control flag cells with control values used to control the flow of executing the test using the test data. In some embodiments of parsing the test spreadsheet and/or the configuration spreadsheet, the testing spreadsheet and the setup configurations within the configuration spreadsheet may be converted into a format that can be executed by the cell based test automation framework, such as a JSON format or other format. As part of parsing the testing spreadsheet, steps are defined within the test case script. That is, a test case script is executed to perform a test. The test case script includes steps that are to be performed as part of the test. A step may include one or more threads. A thread is defined as a row within the testing spreadsheet. The step may relate to creating a volume, performing a mount operation for the volume, performing a fileop (e.g., a write operation to write data to the volume), performing an unmount of all volumes, deleting certain volumes in parallel, deleting certain capacity pools of storage, moving volumes, a backup operation, or any other type of computing or storage operation. Each thread may include a call defined by values within one or more cells of a raw. The call may be defined as an API request that will be framed and transmitted to an API for execution.

During operation 206 of method 200, calls within the testing spreadsheet may be verified using the resource listing file. In particular, calls associated with one or more threads of a step (e.g., an API call performed by a thread) are compared to calls defined within the resource listing file to determine whether there are any mismatches, during operation 208 of method 200. If there is a mismatch, then an error report is generated (e.g., a report that an API being called by a thread cannot be found, and thus there may be an error with the thread), during operation 210 of method 200. Error or failure in one thread won't affect the execution flow of other threads or steps.

If there are no mismatches, then the cell based test automation framework executes the test script (e.g., executing using the JSON file converted from the testing spreadsheet and/or the configuration spreadsheet), during operation 212 of method 200. The cell based test automation framework utilizes the control values to execute threads of the steps to perform calls using the test data. In some embodiments, a call comprises an API request. The API request is framed with a payload and key/value pair from a cell of the testing spreadsheet to create a framed API. The framed API is compared with the resource listing file to select an API as a destination for transmitting the API request (e.g., an API request to create a snapshot may be routed to a snapshot creation API). In some embodiments, a test case includes a thread. The thread comprises an API path in a key/value pair, an API payload, and an expected status code and values expected from a response to the API request. As part of performing a test execution for the thread, a framed API request is sent with the API payload to the API path (API Endpoint) where the API is located. An API response may be received from the API hosted at the API path. The API response may be checked for the expected status code and values. In response to determining that there is a mismatch with the expected status code and/or values, then the thread may be specified as having failed. In response to determining that there is no mismatch with the expected status code and values, then the thread may be specified as having passed. In some embodiments, threads of a step may be executed in parallel as part of a default thread execution rule. However, a serial mode control value may be specified for the step (e.g., a control value within a control flag cell for the thread), which is used to override the default thread execution rule so that the threads are executed serially.

Execution of the test script generates reports, such as console logs, test logs, and debug logs, during operation 214 of method 200. In some embodiments, the test logs and/or the debug logs may be generated in an HTML format or other format. In some embodiments, a debugger is implemented during the execution of the test script in order to generate the debug logs. For example, a control value may be used to pause execution of a step or thread, and enter into a debug mode hosted by the debugger. Any debugging may be logged into the debug log. The console logs may describe steps and threads that were executed, skipped steps and threads that were not executed, and test results. In this way, the cell based test automation framework completes the test.

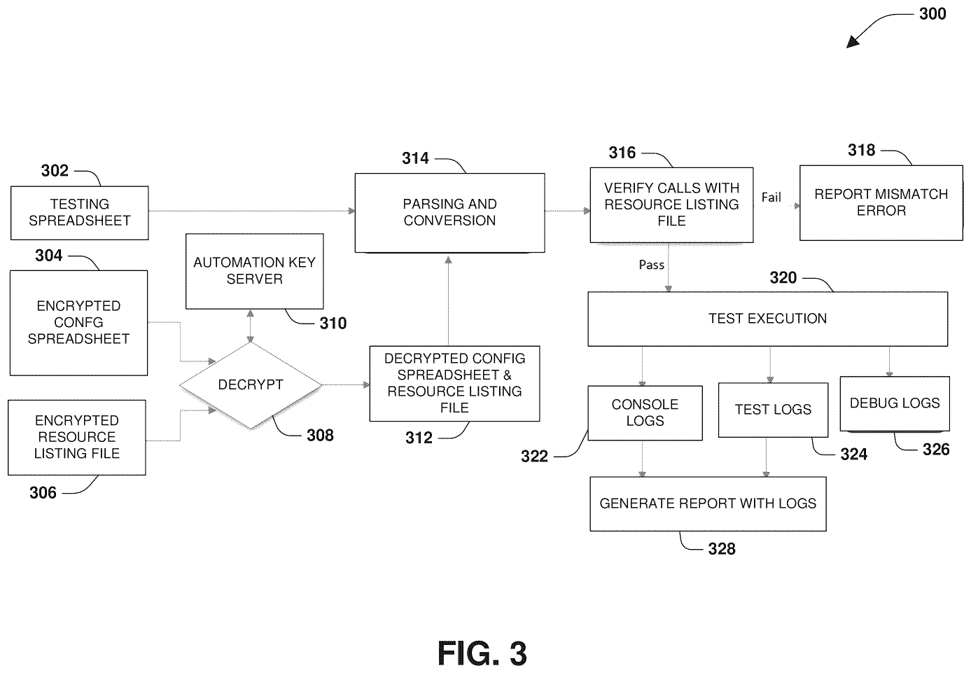

FIG. 3 is a block diagram illustrating an embodiment of a system 300 for implementing a cell based test automation framework. A parsing and conversion component 314 of the cell based test automation framework is configured to parse and convert a testing spreadsheet 302 into a format that can be executed by the cell based test automation framework to perform a test within a computing environment (e.g., a test script with a JSON format). The parsing and conversion component 314 may also utilize a configuration spreadsheet specifying setup configurations for performing the test and utilize a resource listing file of resources (e.g., a list of resources such as APIs that can be called by threads defined as rows within the testing spreadsheet 302). However, the configuration spreadsheet may be maintained as an encrypted configuration spreadsheet 304 and the resource listing file may be maintained as an encrypted resource listing file 306. Accordingly, a decryption process 308 of the cell based test automation framework may utilize an automation key server 310 to decrypt the encrypted configuration spreadsheet 304 and the encrypted resource listing file 306 as decrypted configuration spreadsheet and resource listing file 312 that is input into the parsing and conversion component 314.

As part of parsing and converting the testing spreadsheet 302 and/or the setup configurations within the configuration spreadsheet, a verification process 316 is performed to verify whether calls within threads of the testing spreadsheet 302 match calls within the resource listing file. If a mismatch is detected such as where a thread is attempting to call an API that is not found, then a report 318 of the mismatch is generated. If no mismatch is found, then the cell based test automation framework proceeds with test execution 320 using the converted testing spreadsheet and configuration spreadsheet (e.g., the test script in the JSON format). Console logs 322 and test logs 324 are generated as a report 328 based upon the test execution 320. If debugging is performed during the test execution 320, then debug logs 326 are generated.

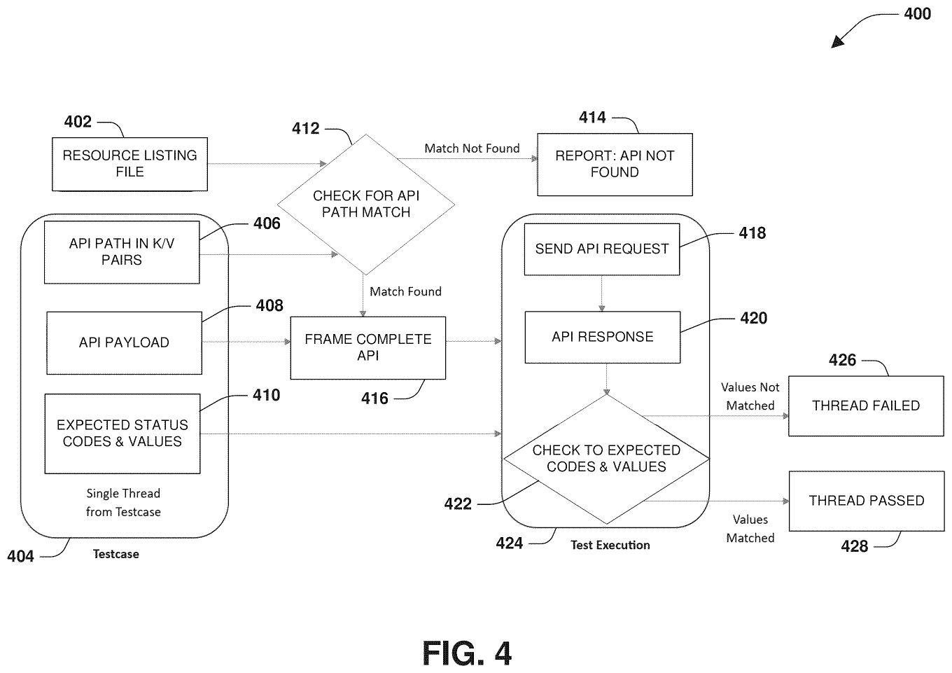

FIG. 4 is a block diagram illustrating an embodiment of a system 400 for implementing a cell based test automation framework. The cell based test automation framework may be configured to perform a test case defined by a testing spreadsheet and a configuration spreadsheet. The test case may include one or more steps, and a step may include one or more threads. A thread 404 may be defined through values populated within cells of a row within the testing spreadsheet. Control values within the testing spreadsheet and/or setup configurations within the configuration spreadsheet may be used to control how the thread 404 is executed by the cell based test automation framework. The thread 404 may include an API path 406 defined through key/value pairs within the cells of the testing spreadsheet (e.g., an API path of a volume move API that is being called by the thread). The thread 404 may include an API payload 408 such as information to input into the volume move API in order to invoke the volume move API to move a volume. The thread 404 may include expected status codes and values 410 that are expected to be returned by the volume move API after execution using the API payload 408.

The thread 404 may be framed 416 into a framed API request that will be transmitted to the API path 406 of the API (e.g., the volume move API) that will execute the framed API request using the information within the API payload 408. The thread 404 is framed 416 into the framed API request if a call by the thread 404 to the API (e.g., the API path 406) matches 413 a resource listing file of APIs available to call (e.g., a list of APIs, API paths, etc.), during operation 412. If the thread is calling an API not found in the resource listing file 402, then a report 414 is generated to indicate that the API could not be found.

Once the thread 404 is framed 416 into the framed API request, the cell based test automation framework implements a test execution 424. The test execution 424 includes sending the framed API request 418 to the API for execution. The API may generate an API response 420 based upon executing the framed API request 418. The API response 420 is compared with the expected status codes and values 410 to determine whether the codes and values match, during operation 422. If there is a mismatch, then the thread is designated as failed 426. If all codes and values match between the API response 420 and the expected status codes and values, then the thread is designated as passed 428. In this way, the cell based test automation framework executes threads of steps that are part of test cases defined through a testing spreadsheet.

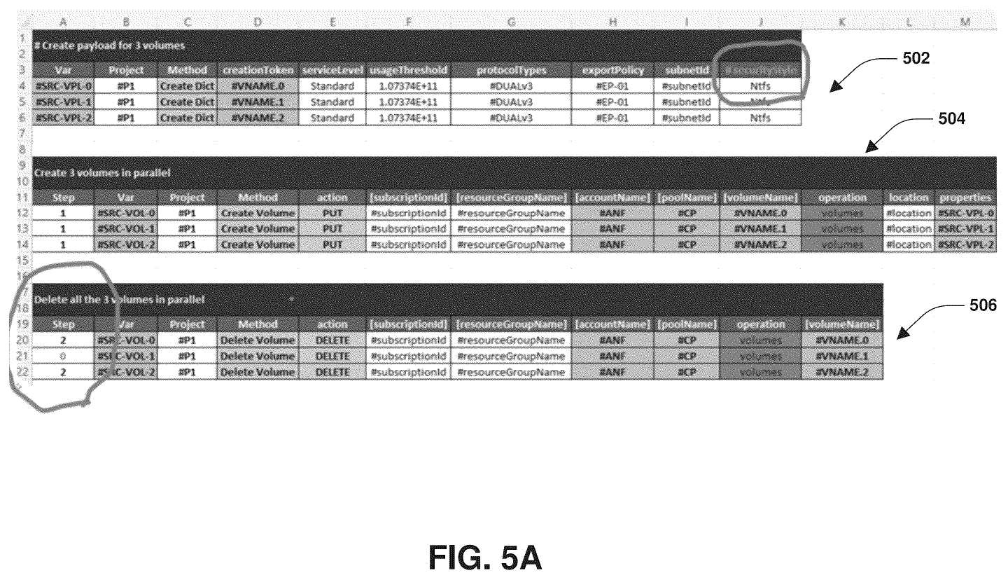

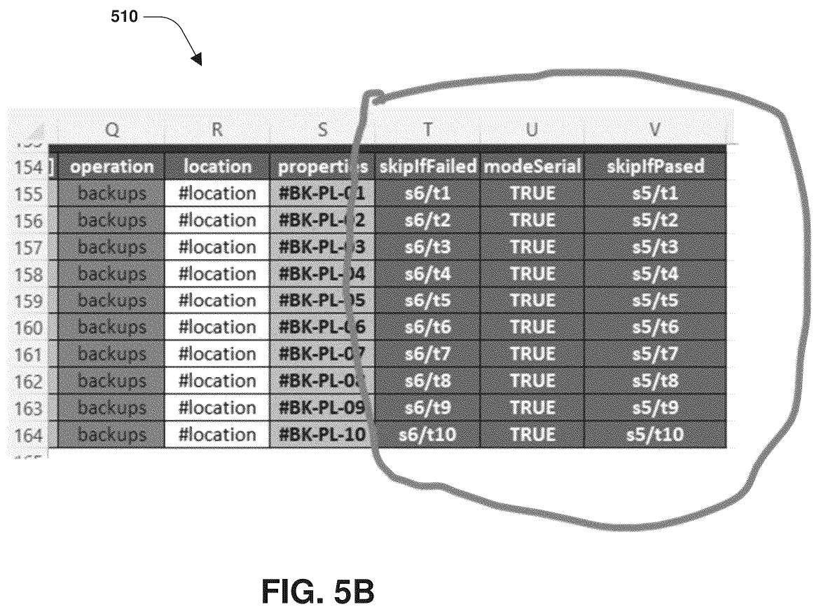

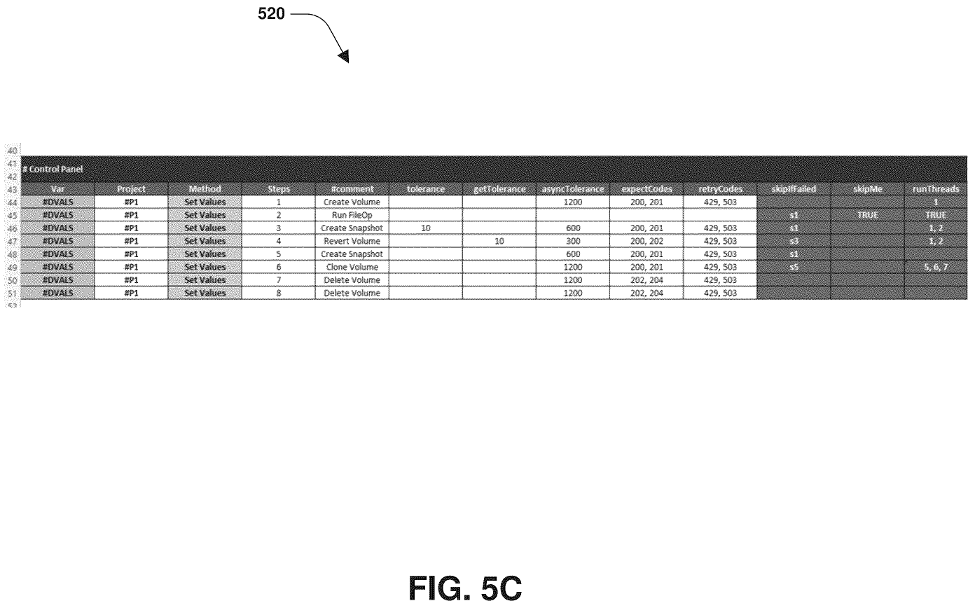

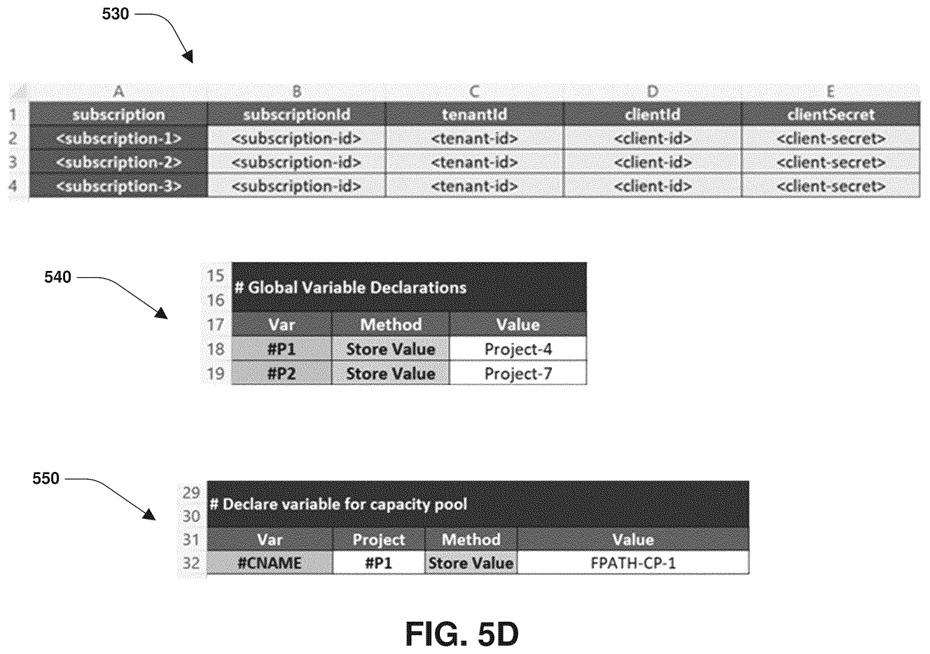

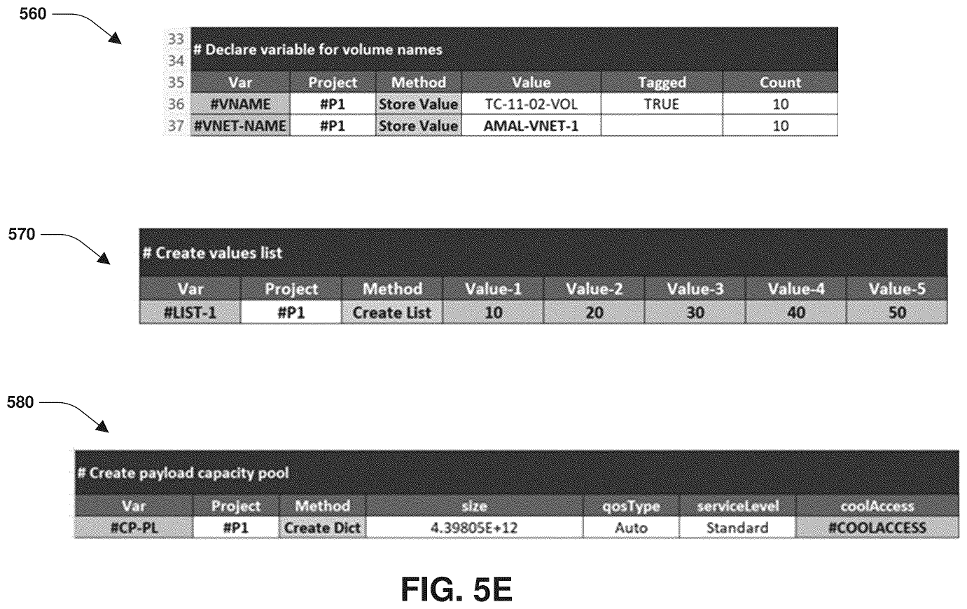

FIGS. 5A-5E are embodiments of spreadsheets used by a cell based test automation framework to perform a test. FIG. 5A illustrates rows within the test spreadsheet that define threads to execute. Each row may represent a thread of a step, and the step may include one or more threads. A first set of threads 502 may relate to methods for creating dictionaries. A first thread is defined on row 4, a second thread is defined on row 5, and a third thread is defined on row 6. The rows are populated with test data and control values in cells along the rows. The cells may relate to a variable column, a project column, a method column (e.g., a create dictionary method to perform), a creation token column, a service level column, a usage threshold column, a protocol types column, an export policy column, a subset ID column, and a security style column. A prefix character (e.g., a hashtag #) has been added to the security style column so that values within the security style column are ignored (e.g., the values are not included within APIs requests/calls defined by the threads and executed by the cell based test automation framework as part of the test). In this way, the first set of threads 502 are used to create a payload for 3 volumes.

A second set of threads 504 may relate to methods for creating 3 volumes in parallel. A first thread is defined on row 12, a second thread is defined on row 13, and a third thread is defined on row 14. The cells of these rows may relate to a step column (e.g., the three threads are part of step 1), a variable column, a project column, a method column (e.g., a create volume method to perform), an action column (e.g., a put operation to be performed), a subscription identifier column, a resource group name column, an account name column, a pool name column, a volume name column, an operation column, a location column, and a properties column. The three threads may be part of a step 1 of a test, where the step 1 is performed to create 3 volumes in parallel.

A third set of threads 506 may relate to methods for deleting 3 volumes in parallel. A first thread is defined on row 20 as being part of step 2, a second thread is defined on row 21 that has been zero out as not being part of a step (e.g., the 0 value within the step column will cause the second thread to not be executed), and a third thread is defined on row 22 as part of the step 2. The cells of these rows may relate to a step column (e.g., the threads are part of step 2,except the second thread defined by row 21 that has been flagged to not be executed), a variable column, a project column, a method column (e.g., a delete volume method to perform), an action column (e.g., a delete operation to be performed), a subscription identifier column, a resource group name column, an account name column, a pool name column, an operation column, and a volume name column. Values/keys in cells that are assigned a prefix character(s) such as # will be ignored

The values within the cells of a row represented a thread are used to frame an API request by comparing and fetching information from a resource listing file. The API request is executed, and a response to the API request is validated. In this way, an API request may be created and executed for each thread that has not been flagged to be skipped for execution.

FIG. 5B illustrates rows within a test spreadsheet 510 that define threads of steps to perform. Columns T, U, and V of the test spreadsheet are populated with control values stored within control flag cells. The control values may relate to threads of step 7. The threads are defined by rows 155 to 164. Column T relates to skip if failed control flag cells where the current thread will be skipped, if the specified step/thread is Failed (e.g., per row 155, step 7 threads are skipped if thread 1 of step 6 fails; per row 156, step 7 threads are skipped if thread 2 of step 6 fails; etc.). Column U relates to mode serial control flag cells where a True value indicates that a thread will be serially executed, instead of being executed in parallel by default. Column V relates to skip if passed control flag cells where the current step will be skipped, if the specified step/thread is passed (e.g., per row 155, step 7 threads are skipped if thread 1 of step 5 passes; per row 156, step 7 threads are skipped if thread 2 of step 5 passes; etc.). s1, s2, etc. correspond to step 1, step 2, etc., respectively, and t1, t2, etc. correspond to thread 1, thread 2, etc., respectively.

FIG. 5C illustrates rows within a test spreadsheet 520 that define control panel information of a control panel. The control panel information is stored along rows where control values are populated within cells of columns, such as a variable column, a project column, a method column, a steps column, a comment column (e.g., a column with a prefix character # to indicate that the values within cells of the comment column are not used to execute threads), a tolerance column, a get tolerance column, an async tolerance column, an expected codes column (e.g., status codes expected to be returned as a response to an API request defined by a thread), a retry codes column (e.g., an API request is retried if a response includes a code within the retry codes column), a skip if failed column, a skip me column (e.g., a thread or step is skipped is a cell in the skip me column is set to True), a run threads column (e.g., threads specified in a cell of the run threads column for a step are executed, and all threads for a step are execute if the value is set to True), etc.

In some embodiments, the control panel provides the ability to control the workflow of test cases. The control panel may be used to define and/or override the flow of steps and threads of a test case. FIG. 5C illustrates 8 steps defined by 8 rows. The control panel describes how the steps must be executed within given tolerance values, what codes are executed, what codes will trigger retries of threads, etc. The values in the control panel will override values specified in cells of rows within a testing spreadsheet for specified steps and threads. The control panel specifies certain operations such as skip if failed (conditional) and skip me (unconditional). s1, s2, etc. corresponding to step 1, step 2, etc., respectively. The operation run threads defines the threads that must be executed, whereas other threads must be skipped. Step 2 will be skipped completely since the field skip me is specified as True. Likewise, all the control flags such test-control flags and flow-control flags can also be used in control-panel similar to its used in each thread.

FIG. 5D illustrates a configuration spreadsheet 530, which includes setup configurations such as information related to subscriptions (e.g., subscriptions to certain software, APIs, or other functionality being called/invoked as part of performing a test), subscription identifiers, tenant identifiers (e.g., identifiers of tenant accounts within a multi-tenant environment), client identifiers, and/or other client secret/sensitive information. The configuration information from the configuration spreadsheet 530 and configurations from a test spreadsheet are used as part of test cases.

In some embodiments, a template sheet contains predefined variables, lists, and dictionary values that could be used across all test case sheets (e.g., each sheet of the testing spreadsheet pertains to a particular test case).

In some embodiments, call value datatypes of a spreadsheet are set through cell formatting, and variables are declared and accessed with prefixing to a variable name (e.g., # volumename).

FIG. 5D illustrates the creation of namespaces using information within a testing spreadsheet 540. Two namespaces, #P1 and #P2, are created for two different projects.

FIG. 5D illustrates single variable assignment where “store value” is stored within a method cell to assign a variable with any data type values under the #P1 project namespace, as illustrated by testing spreadsheet 550.

FIG. 5E illustrates array variable assignment where “store value” is stored within a method cell to assign an array variable with a list of any data type values, and an array size is specified within a count column, as illustrated by testing spreadsheet 560.

FIG. 5E illustrates the creation of a list variable where “create list” is stored within a method cell to create the list variable with values 10, 20, 30, 40, and 50, as illustrated by testing spreadsheet 570.

FIG. 5E illustrates the creation of dictionary keys and values where “create dict” is stored within a method call to create a dictionary (e.g., dictionary keys and/or values), as illustrated by testing spreadsheet 580.

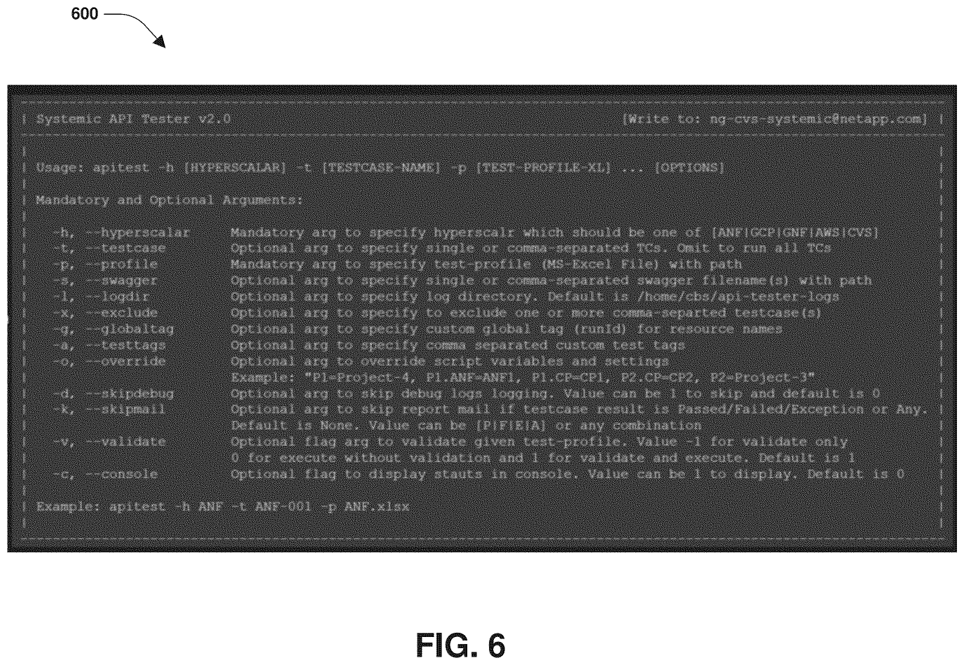

FIG. 6 is an embodiment of test command line syntax 600 used by a cell based test automation framework to perform a test. The test command line syntax 600 includes mandatory and optional arguments for performing a test (e.g., a hyperscalar API test with a particular test case name, test profile, and options). The arguments may include a hyperscalar argument, a test case argument, a profile argument, a swagger argument (e.g., a swagger file used as a resource listing file), a log directory argument, an exclude argument used to exclude one or more test cases defined by a testing spreadsheet, a global tag argument, a test tags argument, an override argument, a skip debug argument, a skip mail argument, a validate argument, and/or a console argument. In this way, the test command line syntax 600 is used to control the cell based test automation framework to perform the test.

FIGS. 7A-7B are embodiments of test results output by a cell based test automation framework while performing a test. The test results include a first portion 700 populated with information regarding a test run identifier, a status, a start time, an end time, a duration, test tags, a test description, and a version (e.g., an API version, a resource listing file version such as a swagger file version, etc.). The test results include a second portion 702 populated with step descriptions such as descriptions for 11 steps being performed as part of a test (e.g., steps to create volumes, update volumes, delete volumes, deleting capacity pools, etc.).

The test results include a third portion 704 describing failures such as where certain threads were skipped or failed as part of performing the test. The test results include a fourth portion 706 that describes execution of threads of a step such as a first thread of a first step. The fourth portion 706 may include a description, a method, a tolerance, an interval, sleep information, a test type, an execution environment, and a status (e.g., passed, a start time, an end time, an event time, an elapse time, a request ID, a correlation ID, a status code returned as a response to an API request by the first thread, etc.).

The test results include a fifth portion 708 that describes execution of threads of a step such as a second thread of the first step. The fifth portion 708 may include a description, a method, a tolerance, an interval, sleep information, a test type, an execution environment, and a status (e.g., passed, a start time, an end time, an event time, an elapse time, a request ID, a correlation ID, a status code returned as a response to an API request by the first thread, etc.). The fifth portion 708 may include information about a request performed by the second thread (e.g., an action being performed, a URL path of an API to perform the request, parameters of the request, a payload of the request, etc.). The fifth portion 708 may include information about a response (e.g., an identifier, a name, a type, a tag, a location, etc.).

The test results are output as test logs that can be easily analyzed by a user, such as for failures, even when the test logs correspond to test cases with numerous steps and thousands of threads.

FIGS. 8A-8B are embodiments of test results output by a cell based test automation framework while performing a test. The test results 800 may specify a swagger file (e.g., a resource listing file) used to verify calls within a testing spreadsheet. The test results 800 may describe a first step, a second step, and a third step that were performed as part of a test defined by the testing spreadsheet. The test results 800 may describe information relating to executing one or more threads of each step, such as whether the threads passed, a duration of the threads, etc. Test results 810 describe steps that were run as part of a test case, threads that were executed, threads that were not executed (e.g., threads that were skipped based upon control values), and/or other information.

FIG. 8C is an embodiment of a debugger 830 of a cell based test automation framework. The debugger 830 provides the ability to resume execution, terminate execution, skip following steps and jump to a specified step number, list all steps that have an execution status, show configuration variables, show global variables, execute a give code line, execute a given shell command, enable pause on test case steps, disable pause on test case steps, enable global pause on steps, disable global pause on steps, hard exit from execution, clear a debug screen, etc.

In some embodiments, a method is provided. The method includes parsing a testing spreadsheet, defining a test case script, to identify test data for performing a test within a computing environment and control flag cells with control values used to control a flow for executing the test using the test data; identifying a step defined within the test case script, wherein the step includes one or more threads defined as rows within the spreadsheet; determining whether calls associated with the one or more threads match calls within a resource listing file; and in response to a call of a thread matching the resource listing file, utilizing the control values to execute the thread to perform the call using the test data as part of executing the test within the computing environment.

In some embodiments, the method comprises utilizing an automation key server to get a key to decrypt an encrypted resource listing file to obtain the resource listing file and to decrypt a configuration spreadsheet to obtain setup configurations for executing the test; and utilizing the setup configurations for performing the test within the computing environment.

In some embodiments, the call comprises an application programming interface (API) request, and the method comprises framing the API request with a payload and key/value pair within a cell of the testing spreadsheet to create a framed API; and comparing the framed API with the resource listing file to select an API as a destination.

In some embodiments, the method comprises defining a first test case as a first sheet within the testing spreadsheet; defining a second test case as a second sheet within the testing spreadsheet; and defining a workbook of the spreadsheet as a group of test cases that include the first test case and the second test case.

In some embodiments, the method comprises implementing a default thread execution rule to execute the one or more threads as a single step; and in response to a serial mode control value being set for the step, overriding the default thread execution rule to serially execute the one or more threads.

In some embodiments, the method comprises performing the test to generate at least one of console logs, test logs in an HTML format, or debug logs in the HTML format.

In some embodiments, the step comprises at least one of a volume create operation, a volume deletion operation, a backup operation, or a storage operation associated with storage of the computing environment.

In some embodiments, the method comprises declaring and accessing a variable by assigning a prefix character to a variable name within the testing spreadsheet.

In some embodiments, the method comprises evaluating the testing spreadsheet to determine that a prefix character (e.g., a # character) is assigned to at least one of a value within a cell of the testing spreadsheet to comment or exclude the value from the call, a method parameter to comment or exclude the method parameter from the call, or a sheet name to exclude or comment a corresponding test case (e.g., each sheet of the testing spreadsheet may relate to a test case to execute); and in response to a value (e.g., a 0 value) being assigned to a cell within a step number column, excluding or commenting a thread defined by a row that includes the cell.

In some embodiments, the method comprises parsing the cells of the testing spreadsheet to convert the testing spreadsheet into a JSON format.

In some embodiments, the method comprises implementing a control panel for each test case of the testing spreadsheet to override test control values, flow control values, step-level values, or thread-level values (e.g., any values specified within cells of the testing spreadsheet) defined by the testing spreadsheet for the test cases (e.g., each sheet within the testing spreadsheet represents a test case, and a control panel may be provided for each sheet/test case), wherein a modification to the control panel modifies a test case without modifying values of steps or threads within the testing spreadsheet defined for the test case (e.g., the control panel is used to modify execution of a test case without modifying the actual values within the testing spreadsheet), and wherein the control panel is populated with a run threads field used to specify one or more threads in one or more steps to execute (e.g., a field/cell is used to specify specific threads that are to be executed).

In some embodiments, a computing device is provided. The computing device comprises a memory comprising machine executable code; and a processor coupled to the memory, the processor configured to execute the machine executable code to cause the machine to: parse a testing spreadsheet, defining a test case script, to identify test data for performing a test within a computing environment and control flag cells with control values used to control a flow for executing the test using the test data; identify a step defined within the test case script, wherein the step includes one or more threads defined as rows within the spreadsheet; determine whether calls associated with the one or more threads match calls within a resource listing file; and in response to a call of a thread matching the resource listing file, utilize the control values to execute the thread to perform the call using the test data as part of executing the test within the computing environment.

In some embodiments, the machine executable code causes the machine to generate, during execution of the test, console logs describing steps and threads that were executed, skipped steps and skipped threads that were not executed, and test results.

In some embodiments, the machine executable code causes the machine to implement, during execution of the test, a debugger to generate debug logs.

In some embodiments, the machine executable code causes the machine to form a test case that includes the thread, wherein the thread comprises an API path in a key/value pair, an API payload, and an expected status code and values expected from a response.

In some embodiments, the machine executable code causes the machine to perform test execution for the thread by sending a framed API request with the API payload to the API path, receiving an API response, and checking the API response for the expected status code and values.

In some embodiments, the machine executable code causes the machine to in response to determining that there is a mismatch with the expected status code and values, specify that the thread failed; and in response to determining that there is no mismatch with the expected status code and values, specify that the thread pass.

In some embodiments, the machine executable code causes the machine to in response to the call of the thread not matching the resource listing file, generate an error report than an API cannot be found.

In some embodiments, a non-transitory machine readable medium is provided. The non-transitory machine readable medium comprises instructions for performing a method, which when executed by a machine, causes the machine to: parse a testing spreadsheet, defining a test case script, to identify test data for performing a test within a computing environment and control flag cells with control values used to control a flow for executing the test using the test data; identify a step defined within the test case script, wherein the step includes one or more threads defined as rows within the spreadsheet; determine whether calls associated with the one or more threads match calls within a resource listing file; and in response to a call of a thread matching the resource listing file, utilize the control values to execute the thread to perform the call using the test data as part of executing the test within the computing environment.

In some embodiments, the instructions cause the machine to: populate a control flag cell with at least one of a skip control value, a jump control value, an exit control value, pause control value, a thread control value, or a batch control value.

In some embodiments, the instructions cause the machine to: populate a control flag cell with at least one of a test log control value, a status control value, a test verification control value, a serial mode flow control value, or a quick mode flow control value.

In some embodiments, the instructions cause the machine to: utilize a command line parameter to alter a value of a variable within the testing spreadsheet for a test case at runtime (e.g., a command line is used to input override values that are used to modify execution of the test case at runtime without modify actual/original values specified within cells of the testing spreadsheet), wherein the test case is run for different test scenarios using override values input through the command line parameter without modifying original values within the testing spreadsheet.

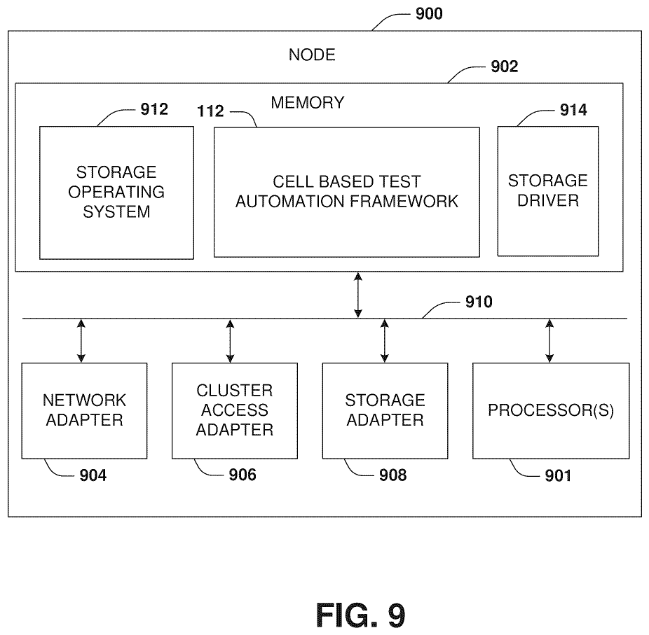

Referring to FIG. 9, a node 900 (also referred to as a storage node) in this particular example includes processor(s) 901, a memory 902, a network adapter 904, a cluster access adapter 906, and a storage adapter 908 interconnected by a system bus 910. In other examples, the node 900 comprises a virtual machine, such as a virtual storage machine.

The node 900 also includes a storage operating system 912 installed in the memory 902 that can, for example, implement a RAID data loss protection and recovery scheme to optimize reconstruction of data of a failed disk or drive in an array, along with other functionality such as deduplication, snapshot creation, data mirroring, synchronous replication, asynchronous replication, encryption, etc.

The network adapter 904 in this example includes the mechanical, electrical and signaling circuitry needed to connect the node 900 to one or more of the client devices over network connections, which may comprise, among other things, a point-to-point connection or a shared medium, such as a local area network. In some examples, the network adapter 904 further communicates (e.g., using Transmission Control Protocol/Internet Protocol (TCP/IP)) via a cluster fabric and/or another network (e.g., a WAN (Wide Area Network)) (not shown) with storage devices of a distributed storage system to process storage operations associated with data stored thereon.

The storage adapter 908 cooperates with the storage operating system 912 executing on the node 900 to access information requested by one of the client devices (e.g., to access data on a data storage device managed by a network storage controller). The information may be stored on any type of attached array of writeable media such as magnetic disk drives, flash memory, and/or any other similar media adapted to store information.

In exemplary data storage devices, information can be stored in data blocks on disks. The storage adapter 908 can include I/O interface circuitry that couples to the disks over an I/O interconnect arrangement, such as a storage area network (SAN) protocol (e.g., Small Computer System Interface (SCSI), Internet SCSI (ISCSI), hyperSCSI, Fiber Channel Protocol (FCP)). The information is retrieved by the storage adapter 908 and, if necessary, processed by the processor(s) 901 (or the storage adapter 908 itself) prior to being forwarded over the system bus 910 to the network adapter 904 (and/or the cluster access adapter 906 if sending to another node computing device in the cluster) where the information is formatted into a data packet and returned to a requesting one of the client devices and/or sent to another node computing device attached via a cluster fabric. In some examples, a storage driver 914 in the memory 902 interfaces with the storage adapter to facilitate interactions with the data storage devices.

The storage operating system 912 can also manage communications for the node 900 among other devices that may be in a clustered network, such as attached to the cluster fabric. Thus, the node 900 can respond to client device requests to manage data on one of the data storage devices or storage devices of the distributed storage system in accordance with the client device requests.

A file system module of the storage operating system 912 can establish and manage one or more file systems including software code and data structures that implement a persistent hierarchical namespace of files and directories, for example. As an example, when a new data storage device (not shown) is added to a clustered network system, the file system module is informed where, in an existing directory tree, new files associated with the new data storage device are to be stored. This is often referred to as “mounting” a file system.

In the example node 900, memory 902 can include storage locations that are addressable by the processor(s) 901 and adapters 904, 906, and 908 for storing related software application code and data structures. The processor(s) 901 and adapters 904, 906, and 908 may, for example, include processing elements and/or logic circuitry configured to execute the software code and manipulate the data structures.

The storage operating system 912, portions of which are typically resident in the memory 902 and executed by the processor(s) 901, invokes storage operations in support of a file service implemented by the node 900. Other processing and memory mechanisms, including various computer readable media, may be used for storing and/or executing application instructions pertaining to the techniques described and illustrated herein.

In some embodiments, the cell based test automation framework 102 is implemented by the node 900 in order to compress images using compression image containers.

The examples of the technology described and illustrated herein may be embodied as one or more non-transitory computer or machine readable media, such as the memory 902, having machine or processor-executable instructions stored thereon for one or more aspects of the present technology, which when executed by processor(s), such as processor(s) 901, cause the processor(s) to carry out the steps necessary to implement the methods of this technology, as described and illustrated with the examples herein. In some examples, the executable instructions are configured to perform one or more steps of a method described and illustrated later.

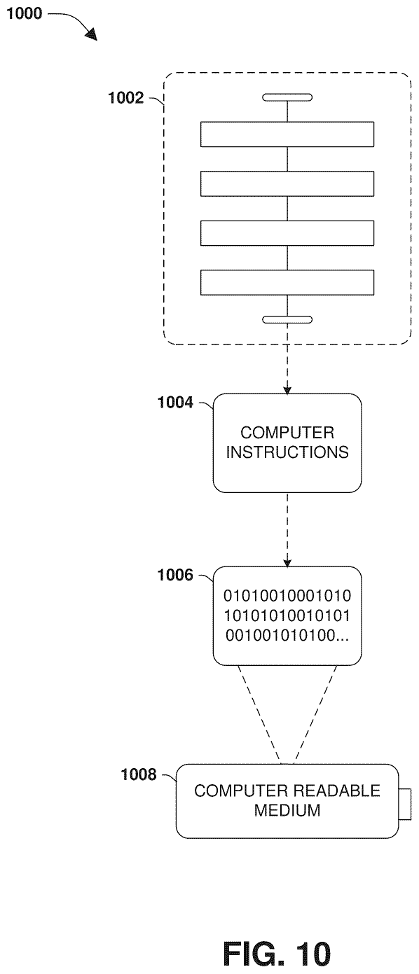

FIG. 10 is an example of a computer readable medium 1000 in which various embodiments of the present technology may be implemented. An example embodiment of a computer-readable medium or a computer-readable device that is devised in these ways is illustrated in FIG. 10, wherein the implementation comprises a computer-readable medium 1008, such as a compact disc-recordable (CD-R), a digital versatile disc-recordable (DVD-R), flash drive, a platter of a hard disk drive, etc., on which is encoded computer-readable data 1006. The computer-readable data 1006, such as binary data comprising at least one of a zero or a one, in turn comprises processor-executable computer instructions 1004 configured to operate according to one or more of the principles set forth herein. In some embodiments, the processor-executable computer instructions 1004 are configured to perform at least some of the exemplary methods 1002 disclosed herein, such as method 200 of FIG. 2, for example. In some embodiments, the processor-executable computer instructions 1004 are configured to implement a system, such as at least some of the exemplary systems disclosed herein, such as system 100 of FIG. 1, system 300 of FIG. 3, and/or system 400 of FIG. 4, for example. Many such computer-readable media are contemplated to operate in accordance with the techniques presented herein.

In some embodiments, the described methods and/or their equivalents may be implemented with computer executable instructions. Thus, in some embodiments, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on. In some embodiments, a computing device is implemented with one or more executable algorithms that are configured to perform any of the disclosed methods.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), electrically erasable programmable read-only memory (EEPROM) and/or flash memory, compact disk read only memory (CD-ROM)s, CD-Rs, compact disk re-writeable (CD-RW) s, DVDs, magnetic tape, optical or non-optical data storage devices and/or any other medium which can be used to store data.

Some examples of the claimed subject matter have been described with reference to the drawings, where like reference numerals are generally used to refer to like elements throughout. In the description, for purposes of explanation, numerous specific details are set forth in order to provide an understanding of the claimed subject matter. It may be evident, however, that the claimed subject matter may be practiced without these specific details. Nothing in this detailed description is admitted as prior art.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Furthermore, the claimed subject matter is implemented as a method, apparatus, or article of manufacture using standard application or engineering techniques to produce software, firmware, hardware, or any combination thereof to control a computer to implement the disclosed subject matter. The term “article of manufacture” as used herein is intended to encompass a computer application accessible from any computer-readable device, carrier, or media. Of course, many modifications may be made to this configuration without departing from the scope or spirit of the claimed subject matter.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, an application, or a computer. By way of illustration, both an application running on a controller and the controller can be a component. One or more components residing within a process or thread of execution and a component may be localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
parsing a testing spreadsheet, defining a test case script, to identify test data for performing a test within a computing environment and control flag cells with control values used to control a flow for executing the test using the test data;
identifying a step defined within the test case script, wherein the step includes one or more threads defined as rows within the spreadsheet;
determining whether calls associated with the one or more threads match calls within a resource listing file; and
in response to a call of a thread matching the resource listing file, utilizing the control values to execute the thread to perform the call using the test data as part of executing the test within the computing environment.

2. The method of claim 1, comprising:
utilizing an automation key server to get a key to decrypt an encrypted resource listing file to obtain the resource listing file and to decrypt a configuration spreadsheet to obtain setup configurations for executing the test; and
utilizing the setup configurations for performing the test within the computing environment.

3. The method of claim 1, wherein the call comprises an application
programming interface (API) request, and wherein the method comprises:
framing the API request with a payload and key/value pair within a cell of the testing spreadsheet to create a framed API; and
comparing the framed API with the resource listing file to select an API as a destination.

4. The method of claim 1, comprising:
defining a first test case as a first sheet within the testing spreadsheet;
defining a second test case as a second sheet within the testing spreadsheet; and
defining a workbook of the spreadsheet as a group of test cases that include the first test case and the second test case.

5. The method of claim 1, comprising:
implementing a default thread execution rule to execute the one or more threads as a single step; and
in response to a serial mode control value being set for the step,
overriding the default thread execution rule to serially execute the one or more threads.

6. The method of claim 1, comprising:
performing the test to generate at least one of console logs, test logs in an HTML format, or debug logs in the HTML format.

7. The method of claim 1, wherein the step comprises at least one of a volume create operation, a volume deletion operation, a backup operation, or a storage operation associated with storage of the computing environment.

8. The method of claim 1, comprising:
declaring and accessing a variable by assigning a prefix character to a variable name within the testing spreadsheet.

9. The method of claim 1, comprising:
evaluating the testing spreadsheet to determine that a prefix character is assigned to at least one of a value within a cell of the testing spreadsheet to comment or exclude the value from the call, a method parameter to comment or exclude the method parameter from the call, or a sheet name to exclude or comment a corresponding test case; and
in response to a value being assigned to a cell within a step number column, excluding or commenting a thread defined by a row that includes the cell.

10. The method of claim 1, comprising:
implementing a control panel for each test case of the testing spreadsheet to override test control values, flow control values, step-level values, or thread-level values defined by the testing spreadsheet for the test cases, wherein a modification to the control panel modifies a test case without modifying values of steps or threads within the testing spreadsheet defined for the test case, and wherein the control panel is populated with a run threads field used to specify one or more threads in one or more steps to execute.

11. A computing device, comprising:
a memory comprising machine executable code; and
a processor coupled to the memory, the processor configured to execute the machine executable code to cause the machine to:
parse a testing spreadsheet, defining a test case script, to identify test data for performing a test within a computing environment and control flag cells with control values used to control a flow for executing the test using the test data;
identify a step defined within the test case script, wherein the step includes one or more threads defined as rows within the spreadsheet;
determine whether calls associated with the one or more threads match calls within a resource listing file; and
in response to a call of a thread matching the resource listing file, utilize the control values to execute the thread to perform the call using the test data as part of executing the test within the computing environment.

12. The computing device of claim 11, wherein the machine executable code causes the machine to:
generate, during execution of the test, console logs describing steps and threads that were executed, skipped steps and skipped threads that were not executed, and test results.

13. The computing device of claim 11, wherein the machine executable code causes the machine to:
implement, during execution of the test, a debugger to generate debug logs.

14. The computing device of claim 11, wherein the machine executable code causes the machine to:
form a test case that includes the thread, wherein the thread comprises an API path in a key/value pair, an API payload, and an expected status code and values expected from a response.

15. The computing device of claim 14, wherein the machine executable code causes the machine to:
perform test execution for the thread by sending a framed API request with the API payload to the API path, receiving an API response, and checking the API response for the expected status code and values.

16. The computing device of claim 15, wherein the machine executable code causes the machine to:
in response to determining that there is a mismatch with the expected status code and values, specify that the thread failed; and
in response to determining that there is no mismatch with the expected status code and values, specify that the thread pass.

17. The computing device of claim 11, wherein the machine executable code causes the machine to:
in response to the call of the thread not matching the resource listing file, generate an error report than an API cannot be found.

18. A non-transitory machine readable medium comprising instructions for performing a method, which when executed by a machine, causes the machine to:
parse a testing spreadsheet, defining a test case script, to identify test data for performing a test within a computing environment and control flag cells with control values used to control a flow for executing the test using the test data;
identify a step defined within the test case script, wherein the step includes one or more threads defined as rows within the spreadsheet;
determine whether calls associated with the one or more threads match calls within a resource listing file; and
in response to a call of a thread matching the resource listing file, utilize the control values to execute the thread to perform the call using the test data as part of executing the test within the computing environment.

19. The non-transitory machine readable medium of claim 18, wherein the instructions cause the machine to:
populate a control flag cell with at least one of a skip control value, a jump control value, an exit control value, pause control value, a thread control value, a batch control value, a test log control value, a status control value, a test verification control value, a serial mode flow control value, or a quick mode flow control value.

20. The non-transitory machine readable medium of claim 18, wherein the instructions cause the machine to:
utilize a command line parameter to alter a value of a variable within the testing spreadsheet for a test case at runtime, wherein the test case is run for different test scenarios using override values input through the command line parameter without modifying original values within the testing spreadsheet.
